(19) United States
(12) Patent Application Publication
(10) Pub. No.: US 2025/0073832 A1
(43) Pub. Date: Mar. 6, 2025

(54) RING SEAL REMOVAL TOOL HAVING INTEGRATED MEASUREMENT DEVICE

(71) Applicant: CATERPILLAR INC., Peoria, IL (US)

(72) Inventors: Joseph J. EVERY, Peoria, IL (US); Dean W. WALTERS, Rapid City, SD (US); Gregory O. POTTS, Washington, IL (US); Vijai THIMMAPURAM, Peoria, IL (US); Michael Scott HEMRY, Maple Grove, MN (US); Luke K. BARROW, Morton, IL (US)

(73) Assignee: CATERPILLAR INC., Peoria, IL (US)

(21) Appl. No.: 18/458,840

(22) Filed: Aug. 30, 2023

(51) Int. Cl. B23P 19/04

(52) U.S. Cl. CPC B23P 19/047

(57) ABSTRACT

A ring seal removal tool may have an elongated body extending from a proximal end to a distal end. The elongated body may have a bottom surface and top surface spaced apart from the bottom surface in a height direction. The ring seal removal tool may also have one of a hook or a prying tip attached to one of the proximal end or the distal end. Further, the ring seal removal tool may have a plurality of cutouts in the elongated body. Each cutout may extend from the top surface of the elongated body towards the bottom surface of the elongated body. Each cutout of the plurality of cutouts may be configured to receive a portion of a ring seal having an outer diameter about equal to a width of the cutout.

### TECHNICAL FIELD

The present disclosure relates generally to a ring seal removal tool, and more particularly, to a ring seal removal tool having an integrated measurement device.

### BACKGROUND

A variety of ring seals are typically employed in one or more components of construction equipment. For example, such components may include actuators, pumps, fluid tanks, or fluid connections. A ring seal may help to prevent leakage of fluids contained within a component or component assembly to the ambient environment surrounding the component. For example, one or more ring seals may be used in a hydraulic cylinder to prevent leakage of hydraulic fluid from within the hydraulic cylinder to the outside environment. A ring seal may also prevent entry of air, water, and/or environmental debris (e.g., dirt or dust) from the ambient to inner portions of the components.

Over time, a ring seal may degrade, resulting in a change in the ring seal properties such as its elasticity that may decrease the ability of the ring seal to provide adequate sealing between the inside of a component and the outside environment. In such cases, it may be necessary to remove the ring seal from the component and replace it with the new ring seal. A ring seal removal tool may be used to remove a ring seal attached to a component. The ring seal replacement tool must be effective at removal, should not scratch the groove or other feature in which the ring seal is installed, and should be strong enough to be reusable.

U.S. Pat. No. 4,813,120 of Fournier issued on Mar. 21, 1989 (“the '989 patent”) and discloses a tool for extracting seated O-rings from a confining annular indentation. The disclosed tool has an elongated O-ring prying section coupled to a knurled handle. A surface of the prying section is slipped between the O-ring and the wall of the annular recess such that an upper surface of the prying section is in contact with the right hand portion of the O-ring. Thereafter the handle is displaced downwardly so that the O-ring is lifted or pried out of the recess. Although the '989 patent discloses a tool for extracting a seated O-ring, the disclosed tool does not allow an operator to determine a size of the replacement O-ring. Thus, the operator requires another measurement tool or gauge to determine the size of the replacement O-ring. The need to use an additional tool makes the replacement process cumbersome and increases the cost due to the added cost of the measurement tool, which may be undesirable.

The disclosed ring seal removal tool of the present disclosure solves one or more of the problems set forth above and/or other problems of the prior art.

### SUMMARY

In one aspect, the present disclosure is directed to a ring seal removal tool. The ring seal removal tool may include an elongated body extending from a proximal end to a distal end. The ring seal removal tool may also include a hook extending from the proximal end. Further, the ring seal removal tool may include a prying tip extending from the distal end. The ring seal removal tool may also include a cutout in the elongated body. The cutout may be configured to receive a portion of a ring seal having an outer diameter about equal to a width of the cutout.

In another aspect, the present disclosure is directed to a ring seal removal tool. The ring seal removal tool may include an elongated body extending from a proximal end to a distal end. The elongated body may include a bottom surface and top surface spaced apart from the bottom surface in a height direction. The ring seal removal tool may also include one of a hook or a prying tip attached to one of the proximal end or the distal end. Further, the ring seal removal tool may include a plurality of cutouts in the elongated body. Each cutout may extend from the top surface of the elongated body towards the bottom surface of the elongated body. Each cutout of the plurality of cutouts may be configured to receive a portion of a ring seal having an outer diameter about equal to a width of the cutout.

### BRIEF DESCRIPTION OF THE DRAWINGS

FIG. 1 is an illustration of an exemplary embodiment of a ring seal removal tool;

FIG. 2 is an exemplary illustration of a side elevation view of the ring seal removal tool of FIG. 1;

FIG. 3 is an exemplary illustration of a cross-sectional view of the ring seal removal tool of FIGS. 1 and 2 along section line A-A shown in FIG. 2;

FIG. 4 is another exemplary illustration of a cross-sectional view of the ring seal removal tool of FIGS. 1 and 2 along section line B-B shown in FIG. 2;

FIG. 5 illustrates a magnified view of a proximal portion of the ring seal removal tool of FIG. 1;

FIG. 6 illustrates a magnified view of a distal portion of the ring seal removal tool of FIG. 1;

FIG. 7 illustrates a magnified view of a central portion of the ring seal removal tool of FIG. 1; and

FIG. 8 is an illustration of another exemplary embodiment of a ring seal removal tool.

### DETAILED DESCRIPTION

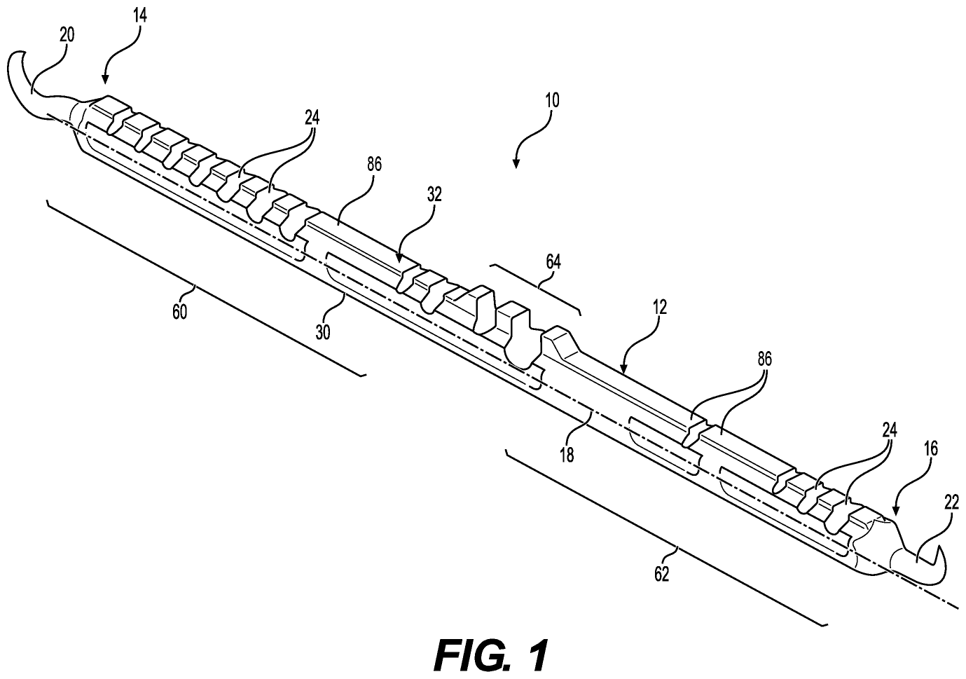

FIG. 1 illustrates an exemplary embodiment of ring seal removal tool 10. As illustrated in FIG. 1, ring seal removal tool 10 may include elongated body 12 that may extend from proximal end 14 to distal end 16 along longitudinal axis 18 of elongated body 12. Elongated body 12 may have any desired length. Hook 20 may extend outwardly from proximal end 14 and prying tip 22 may extend outwardly from distal end 16, or vice-versa. It is also contemplated that in some exemplary embodiments, ring seal removal tool 10 may include only one of hook 20 or prying tip 22 attached to one of proximal end 14 or distal end 16. As further illustrated in FIG. 1, ring seal removal tool 10 may include one or more cutouts 24 in elongated body 12. Each cutout 24 may be configured to receive a ring seal having an outer diameter about equal to a width of that cutout 24.

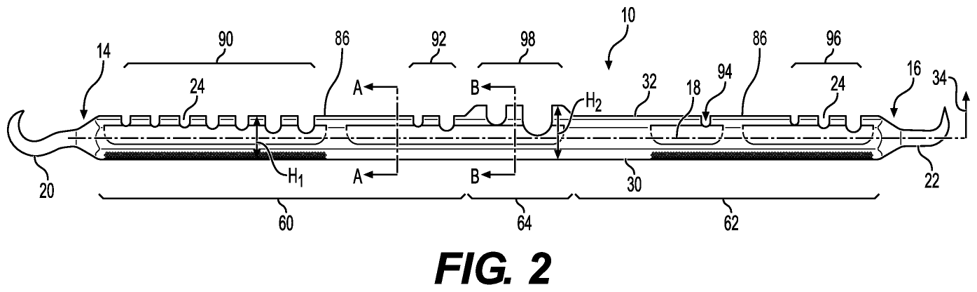

FIG. 2 illustrates an exemplary side elevation view of ring seal removal tool 10. As illustrated in FIG. 2, ring seal removal tool 10 may include first surface (or bottom surface) 30 and second surface (or top surface) 32 spaced apart from first surface 30 in a height direction 34 that may be transverse to longitudinal axis 18. In one exemplary embodiment as illustrated in FIG. 2, height direction 34 may be disposed generally perpendicular to longitudinal axis 18. As also illustrated in FIG. 2, cutout 24 may extend into elongated body 12 from second surface 32 towards first surface 30 in a direction opposite to height direction 34. It is to be understood that the terms “generally” and “about” as used in this disclosure may represent dimensions that may include typical design, material, manufacturing, and/or machining tolerances and variations. Thus, for example, the term “generally perpendicular” may encompass angles ranging between 90°±5°.

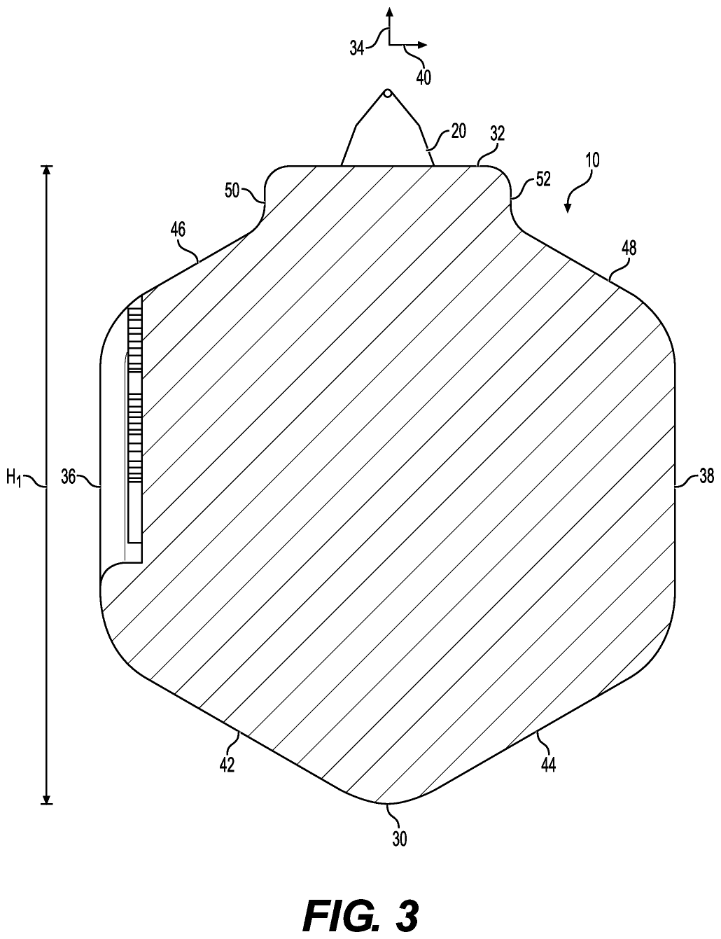

FIG. 3 illustrates an exemplary cross-sectional view of ring seal removal tool 10 along section line A-A as shown in FIG. 2. As illustrated in the exemplary embodiments of FIGS. 2 and 3, elongated body 12 may have a height “H₁” between first surface 30 and second surface 32. As also illustrated in FIG. 3, elongated body 12 may have third surface (or front surface) 36 and fourth surface (or rear of surface) 38 that may be spaced apart from third surface 36 along a width direction 40 that may be transverse to both longitudinal axis 18 and height direction 34. In one exemplary embodiment as illustrated in FIG. 3, width direction 40 may be disposed generally perpendicular to both height direction 34 and longitudinal axis 18. As also illustrated in FIG. 3, elongated body 12 may have a generally polygon shaped cross-sectional area. For example, as illustrated in FIG. 3, angled bottom surfaces 42 and 44 may connect first surface 30 with third and fourth surfaces 36 and 38, respectively. Similarly, angled top surfaces 46 and 48 may connect second surface 32 with third and fourth surfaces 36 and 38, respectively, via vertical surfaces 50 and 52, respectively. It is contemplated that, the cross-section of elongated body 12 may have more than or less than surfaces 36, 38, 42, 44, 46, 48, 50, and/or 52. For example, in some exemplary embodiments, the cross-section of elongated body 12 may not include vertical surfaces 50 and 52. It is also contemplated that a shape of cross-sectional area of elongated body 12 may, for example, be circular, elliptical, rectangular, square, triangular, or any other shape.

Elongated body 12 may be divided into a plurality of portions. For example, in one exemplary embodiment as illustrated in FIG. 2, elongated body 12 may be divided into three portions: proximal portion 60, distal portion 62, and central portion 64. It is contemplated, however, that elongated body 12 may have fewer than or more than 3 portions having similar or different dimensions and/or cross-sectional area shapes. Proximal portion 60 of elongated body 12 may extend from proximal end 14 towards distal end 16. Distal portion 62 of elongated body 12 may extend from distal end 16 towards proximal end 14. Central portion 64 of elongated body 12 may extend between and connect proximal portion 60 and distal portion 62. Elongated body 12 may have a generally similar cross-sectional area in proximal portion 60 and distal portion 62. However elongated body 12 may have a cross-sectional area in central portion 64 that may have a different shape or may be larger in area as compared to a cross-sectional area of elongated body 12 in proximal portion 60 and/or distal portion 62.

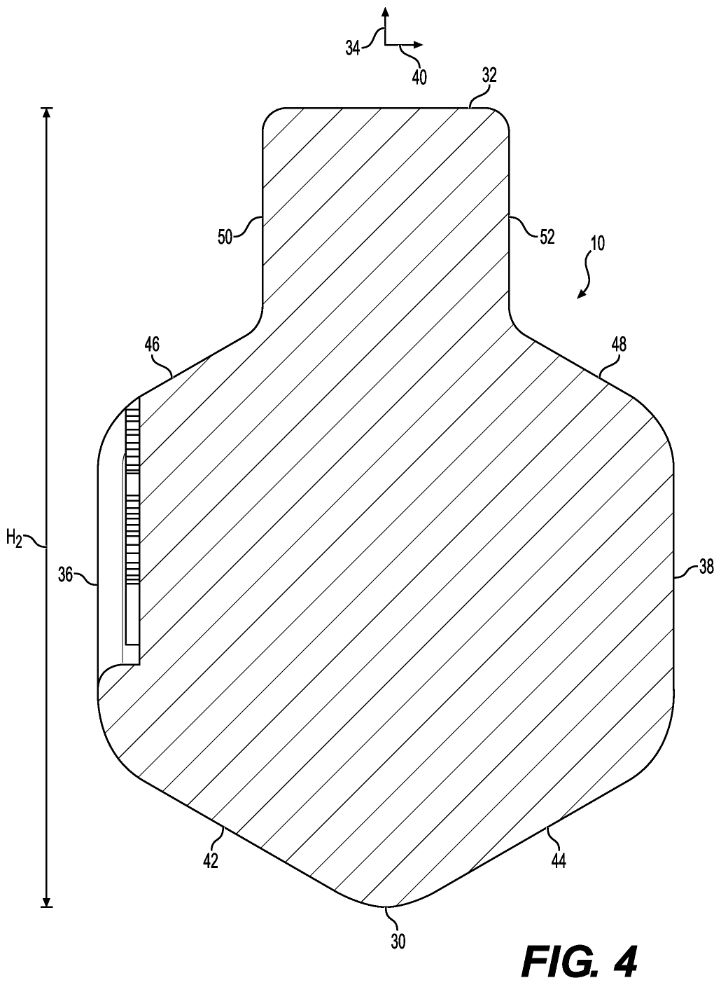

FIG. 4 illustrates an exemplary cross-sectional view of ring seal removal tool 10 along section line B-B as shown in FIG. 2. As illustrated in the exemplary embodiments of FIGS. 2 and 4, elongated body 12 may have a height “H₂” between first surface 30 and second surface 32. Height H₂ of central portion 64 may be greater than height H₁ of proximal portion 60 and/or distal portion 62 of elongated body 12. As also illustrated in the exemplary embodiment of FIG. 4, the cross-sectional area of elongated body 12 in central portion 64 may include angled bottom surfaces 42 and 44 that may connect third and fourth surfaces 36 and 38, respectively, with first surface 30. Similarly, the cross-sectional area of elongated body 12 in central portion 64 may include angled top surfaces 46 and 48 that may connect third and fourth surfaces 36 and 38, respectively, with second surface 32 via vertical surfaces 50 and 52, respectively. A comparison of FIGS. 3 and 4 illustrates that vertical surfaces 50 and 52 may be longer (e.g., have more height in height direction 34) in central portion 64 (as shown in FIG. 4) relative to the dimensions of vertical surfaces 50 and 52 in proximal portion 60 and/or distal portion 62 (as shown in FIG. 3). It is contemplated that, the cross-section of elongated body 12 in central portion 64 may have more than or less than surfaces 36, 38, 42, 44, 46, 48, 50, and/or 52. It is also contemplated that the cross-section of elongated body 12 in central portion 64 may have any other shape, for example, circular, elliptical, rectangular, square, triangular, or any other desired shape. It is further contemplated that one or more of proximal portion 60, distal portion 62, and central portion 64 may have the same or different cross-sectional shapes and/or sizes. Although central portion 64 has been discussed and illustrated as having a larger cross-sectional area and/or larger height H₂ as compared to the cross-sectional areas and/or heights H₁, respectively, of proximal portion 60 and distal portion 62, in some exemplary embodiments, one or both of proximal portion 60 and/or distal portion 62 may have a larger cross-sectional area and/or height compared to the other portions of elongated body 12. Although proximal portion 60 and distal portion 62 of elongated body 12 have been illustrated in FIG. 2 and discussed as having a same height H₁ and/or a similar cross-sectional shape and area, it is contemplated that in some exemplary embodiments, a height, cross-sectional shape, and/or area of proximal portion 60 may be different from a height, cross-sectional shape, and/or area, respectively of distal portion 62.

Returning to FIG. 2, some or all of the first surface 30 of elongated body 12 may be textured to provide an improved gripping surface. For example, as illustrated in the exemplary embodiment of FIG. 2, parts of first surface 30 in proximal portion 60 and distal portion 62 of elongated body 12 of ring seal removal tool 10 may be textured. It is contemplated that in some exemplary embodiments, some or all of proximal portion 60, distal portion 62, and/or central portion 64 of elongated body 12 of ring seal removal tool 10 may be textured. It is also contemplated, however, that in some exemplary embodiments of ring seal removal tool 10, none of the proximal portion 60, distal portion 62, and/or central portion 64 may be textured.

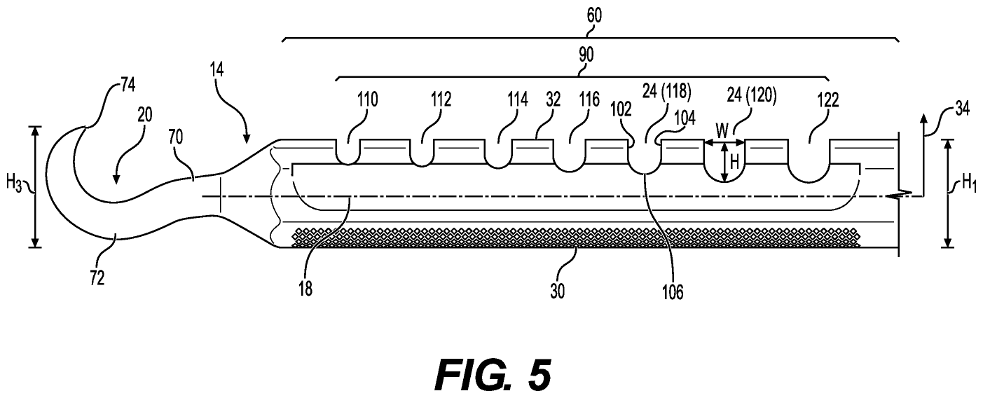

FIG. 5 illustrates a magnified view of proximal portion 60 of elongated body 12 and hook 20. Hook 20 may include shank 70, bend 72, and tip 74. Hook 20 may be attached to proximal end 14 of elongated body 12 such that tip 74 may extend in height direction 34 relative to shank 70 and bend 72. As illustrated in FIG. 5, one end of shank 70 may be connected to proximal end 14 of elongated body 12 of ring seal removal tool 10. Bend 72 may extend from an opposite end of shank 70 to tip 74. Bend 72 may include a generally curvilinear body such that a portion of bend 72 may be spaced apart from first surface 30 in the direction opposite to height direction 34. It is contemplated, however, that in some exemplary embodiments, at least a portion of an outer surface of bend 72 may be coplanar with first surface 30. Tip 74 may extend past second surface 32 in height direction 34. Thus, for example, in one exemplary embodiment as illustrated in FIG. 5, a height “H₃” of tip 74 relative to first surface 30 may be greater than height H₁ of elongated body 12.

In some exemplary embodiments, hook 20 may be an integral portion of ring seal removal tool 10 such that hook 20 may be formed integrally with elongated body 12. In other exemplary embodiments, hook 20 may be removably attachable to elongated body 12 at proximal end 14 of elongated body 12. In one exemplary embodiment, hook 20 may be threadedly attached to elongated body 12 at proximal end 14. For example, elongated body 12 may have female threads extending into elongated body 12 from proximal end 14 along longitudinal axis 18, and a portion of shank 70 of hook may include male threads that may engage with the female threads in elongated body 12. In another exemplary embodiment, hook 20 may be attached to proximal end 14 of elongated body 12 via a press fit. For example, elongated body 12 may include a blind hole extending into elongated body 12 from proximal end 14 along longitudinal axis 18. The blind hole may include one or more indentations. Shank 70 of hook 20 may include one or more projections that may engage with the one or more indentations in the blind hole of elongated body 12 when shank 70 is inserted or pressed into the blind hole. It is also contemplated that hook 20 may be attached to proximal end 14 of elongated body 12 using fasteners or rivets, or by welding, brazing, adhesion and/or any other method of attachment.

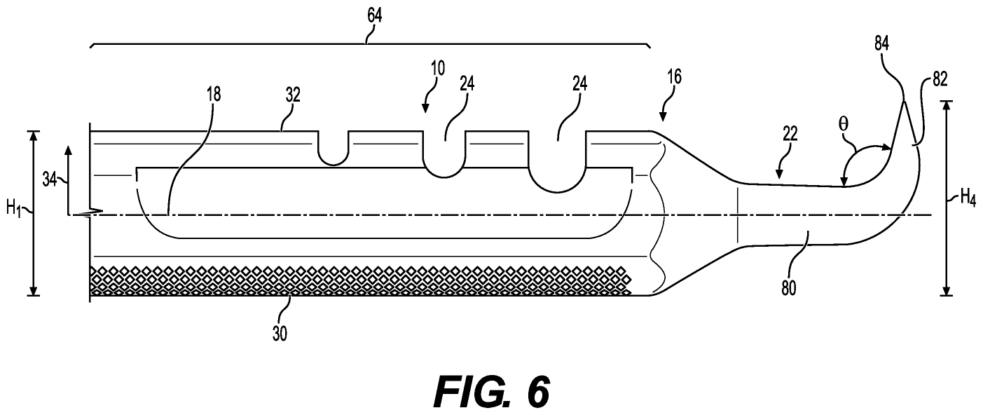

FIG. 6 illustrates a magnified view of distal portion 62 of elongated body 12 and prying tip 22. Prying tip 22 may include shank 80, tip portion 82 and tip end 84. Prying tip 22 may be attached to distal end 16 of elongated body 12 such that tip end 84 may extend in height direction 34 relative to shank 80. One end of shank 80 of prying tip 22 may extend along the longitudinal axis 18 from distal end 16 of elongated body 12 in a direction from proximal end 14 towards distal end 16. Tip portion 82 may extend from an opposite end of shank 80 and may be bent relative to shank 80 in a direction transverse to the longitudinal axis 18. In one exemplary embodiment as illustrated in FIG. 6, tip portion 82 may be positioned such that tip end 84 may project beyond second surface 32 in height direction 34. Thus, for example, a height “H₄” of tip end 84 relative to the first surface 30 may be greater than height H₁ of elongated body 12. Tip portion 82 may be disposed at an angle θ relative to shank 80 of prying tip 22. Angle θ may range between about 90° and 150°. Thus, for example, in some exemplary embodiments tip portion 82 may be disposed at an obtuse angle relative to shank 80 of prying tip 22. As also illustrated in the exemplary embodiment of FIGS. 1 and 6, tip portion 82 may have a generally conical shape. It is contemplated, however, that tip portion 82 may have other shapes (e.g., pyramid, wedge, hexahedral).

In some exemplary embodiments, prying tip 22 may be an integral portion of ring seal removal tool 10 such that prying tip 22 may be formed integrally with elongated body 12. In other exemplary embodiments, prying tip 22 may be removably attachable to elongated body 12 at distal end 16 of elongated body 12. In one exemplary embodiment, prying tip 22 may be threadedly attached to elongated body 12 at distal end 16. For example, elongated body 12 may have female threads extending into elongated body 12 from distal end 16 along longitudinal axis 18, and a portion of shank 80 of prying tip 22 may include male threads that may engage with the female threads in elongated body 12. In another exemplary embodiment, prying tip 22 may be attached to distal end 16 of elongated body 12 via a press fit. For example, elongated body 12 may include a blind hole extending into elongated body 12 from distal end 16 along longitudinal axis 18. The blind hole may include one or more indentations. Shank 80 of prying tip 22 may include one or more projections that may engage with the one or more indentations in the blind hole of elongated body 12 when shank 80 is inserted or pressed into the blind hole. It is also contemplated that hook 20 may be attached to distal end 16 of elongated body 12 using fasteners or rivets, or by welding, brazing, adhesion and/or any other method of attachment.

Returning to FIG. 2, ring seal removal tool 10 may include a plurality of cutouts 24. In one exemplary embodiment as illustrated in FIG. 2, the plurality of cutouts 24 may be grouped into a first group of cutouts 90, second group of cutouts 92, third group of cutouts 94, fourth group of cutouts 96, and fifth group of cutouts 98. As further illustrated in FIG. 2, the first and second group of cutouts 90 and 92 may be disposed on proximal portion 60 of elongated body 12, the third and the fourth group of cutouts 94 and 96 may be disposed on distal and 62 of elongated body 12, and the fifth group of cutouts 98 may be disposed on central portion 64 of elongated body 12. Although five groups of cutouts 90, 92, 94, 96, and 98 have been illustrated in FIG. 2, it is contemplated that elongated body 12 of ring seal removal tool 10 may have more than or fewer than five groups of cutouts. For example, in some exemplary embodiments, elongated body 12 of ring seal removal tool may include three groups of cutouts 90, 96, and 98 such that a first group of cutouts 90 may be disposed on proximal portion 60, a second group of cutouts 96 may be disposed on distal portion 62, and a third group of cutouts 96 may be disposed on central portion 64. Further, it is contemplated that more than or less than two groups of cutouts may be disposed on any of proximal portion 60, distal portion 62, and/or central portion 64 of elongated body 12. It is also contemplated that each group of cutouts (e.g., 90, 92, 94, 96, and/or 98) may include any number of cutouts 24. As also illustrated in FIGS. 1 and 2, elongated body 12 may include cutout free portions 86 that may not include any cutouts 24. Cutout free portions 86 may provide one or more locations for holding ring seal removal tool 10 and/or for manipulating ring seal removal tool 10 while removing a ring seal. It is also contemplated that cutouts 24 in the one or more groups of cutouts 90, 92, 94, 96, and 98 may also provide gripping surfaces that may allow an operator to hold and/or manipulate ring seal removal tool 10 during removal of a ring seal. For example, the third and fourth surfaces 36, 38 in proximal portion 60, distal portion 62, and/or central portion 64 may provide an improved gripping surface 36 or 38, resulting from cutouts 24 separated intermediate uncut portions of third and fourth side surfaces 36, 38.

Referring to FIG. 5, each cutout 24 may be defined by a pair of planar surfaces 102 and 104 disposed spaced apart from each other in a direction parallel to longitudinal axis 18. A distance “W” may define a width of the gap between planar surfaces (or walls) 102 and 104 of each cutout 24. Each cutout 24 may also include a curvilinear surface 106 (or bottom wall 106) that may extend between and connect planar surfaces 102 and 104. In one exemplary embodiment, curvilinear surface 106 may be a generally semi-cylindrical surface. Dimension “H” along height direction 34 may define a height of cutout 24. It is contemplated that height H may be greater than or about equal to width W of cutout 24. It is also contemplated that height H of any cutout 24 may be smaller than heights H₁ and H₂ of elongated body 12. In some exemplary embodiments, height H of any cutout 24 in proximal portion 60 or distal portion 62 of elongated body 12 may be about equal to or smaller than one half of height H₁ to ensure structural integrity of elongated body 12 and to minimize a likelihood of elongated body 12 bending and/or breaking in a vicinity of curvilinear surface 106. Similarly, in some exemplary embodiments, height H of any cutout 24 in central portion 64 of elongated body 12 may be about equal to or smaller than one half of height H₂. Cutout 24 may be configured to receive at least a portion of a ring seal such that the ring seal may be insertable into cutout 24 without causing any deformation of the ring seal. That is, a ring seal having a cross-section that has an outer diameter about equal to width W of cutout 24 may be insertable into cutout 24 without causing any deformation of the ring seal. In some embodiments, the height H of cutout 24 may be about equal to width W of cutout 24 so that when a portion of the ring seal is inserted into the cutout 24, the ring seal may bottom out on curvilinear surface 106 and an upper surface of the ring seal may be coplanar with second surface 32 of elongated body 12.

FIG. 5 illustrates the first group of cutouts 90 that may be disposed adjacent to proximal end 14 of elongated body 12. First group of cutouts 90 may include a plurality of cutouts 24. For example, as illustrated in FIG. 5, the first group of cutouts 90 may include cutouts 110, 112, 114, 116, 118, 120, and/or 122. A first cutout 110 may be disposed adjacent to proximal end 14 and a second cutout 122 may be spaced apart from first cutout 110. Second cutout 122 may be disposed adjacent to central portion 64 of elongated body 12. A plurality of intermediate cutouts 112, 114, 116, 118, 120 of increasing widths and/or heights may be disposed between the first cutout 110 and the second cutout 122. For example, as illustrated in FIG. 5, cutouts 110, 112, 114, 116, 118, 120, and/or 120 may be of different sizes. In one exemplary embodiment as illustrated in FIG. 5, the width W and height H of cutouts 110, 112, 114, 116, 118, 120, and/or 120 may increase with increasing distance from proximal end 14. For example, cutout 110 may have a smallest width W and smallest height H of the cutouts in first group of cutouts 90, and cutout 122 may have a largest width W and largest height H of the cutouts in first group of cutouts 90. Further, moving in a direction from proximal end 14 towards distal end 16, the widths and heights of each successive cutout may be larger than a width and height of any prior cutouts. Thus, for example, a width and height of cutout 112 may be larger than a width and height of cutout 110, a width and height of cutout 114 may be larger than a width and height of cutout 112, a width and height of cutout 116 may be larger than a width and height of cutout 114, and so on. The widths and heights of successive cutouts 24 in one or more of the second group of cutouts 92, third group of cutouts 94, fourth group of cutouts 96, and/or fifth group of cutouts 98 may also increase in a direction from the proximal end towards the distal end. That is, first cutout 110 may have a first width that may be smaller than widths of intermediate cutouts 112, 114, 116, 118, 120 and width of second cutout 122. Likewise, second cutout 122 may have a second width that may be larger than the widths of intermediate cutouts 112, 114, 116, 118, 120 and width of and width of first cutout 110.

It is contemplated, however, that in some exemplary embodiments, the width W and height H of cutouts 110, 112, 114, 116, 118, 120, and/or 120 may decrease with increasing distance from proximal end 14. Thus, for example, a width and height of cutout 112 may be smaller than a width and height of cutout 110, a width and height of cutout 112 may be smaller than a width and height of cutout 114, a width and height of cutout 114 may be smaller than a width and height of cutout 116, and so on. It is also contemplated that in some exemplary embodiments, the width W and height H of cutouts 110, 112, 114, 116, 118, 120, and/or 120 may not increase or decrease sequentially.

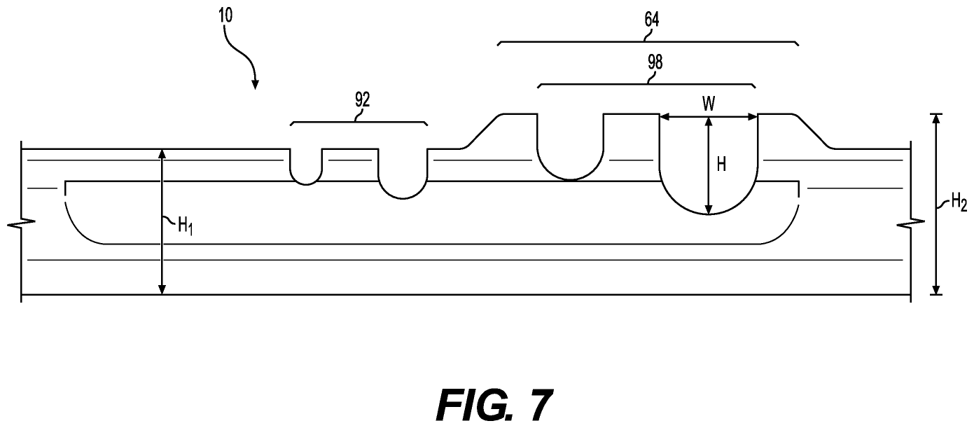

FIG. 7 illustrates a magnified view of central portion 64 of elongated body 12. Central portion 64 may include one or more cutouts 24. As illustrated in FIG. 7, cutout 24 in central portion 64 may have a height H that may be smaller than height H₂ of elongated body 12 in central portion 64. In some exemplary embodiments, height H of cutout 24 in central portion 64 may be greater than height H₁ of proximal and distal portions 60, 62 of elongated body 12 but less than height H₂ of central portion 64 of elongated body 12. It is also contemplated that height H of cutout 24 in central portion 64 may be about equal to or smaller than half of height H₂. to ensure structural integrity of elongated body 12 and to minimize a likelihood of elongated body 12 bending and/or breaking in a vicinity of curvilinear surface 106 of cutout 24. It is further contemplated that height H of cutout 24 in central portion 64 may be about greater than half of height H₁ of proximal portion 60 and/or distal portion 62.

The dimensions of cutouts 24 in each group of cutouts (e.g., 90, 92, 94, 96, and/or 98) may be selected based on the dimensions of ring seals being used on a particular component, a group of components, a particular machine, a group of machines, or based on any other criterion. For example, when a particular component (e.g., hydraulic cylinder, pump) uses O-rings having diameters ranging between 1 mm and 6 mm, the width and height of cutouts 24 in first group of cutouts 90 may range between 1 mm and 6 mm. It is to be understood that the range of 1 mm to 6 mm is exemplary and nonlimiting and any other dimensional range may be used. In one exemplary embodiment, one or more of the group of cutouts (e.g., 90, 92, 94, 96, and/or 98) may include cutouts 24 having dimensions based on an industry standard such as a Society of Automotive Engineers (SAE) standard. It is also contemplated that one or more of the group of cutouts (e.g., 90, 92, 94, 96, and/or 98) may include cutouts 24 having dimensions in a predetermined system of measurement units. For example, in one exemplary embodiment, cutouts 24 in first group of cutouts 90, disposed adjacent to proximal end 14, may have widths and heights specified in English units (e.g., inches, mils) and cutouts 24 in fourth group of cutouts 96, disposed adjacent to distal end 16 may have widths and heights specified in Metric units (e.g., mm, cm).

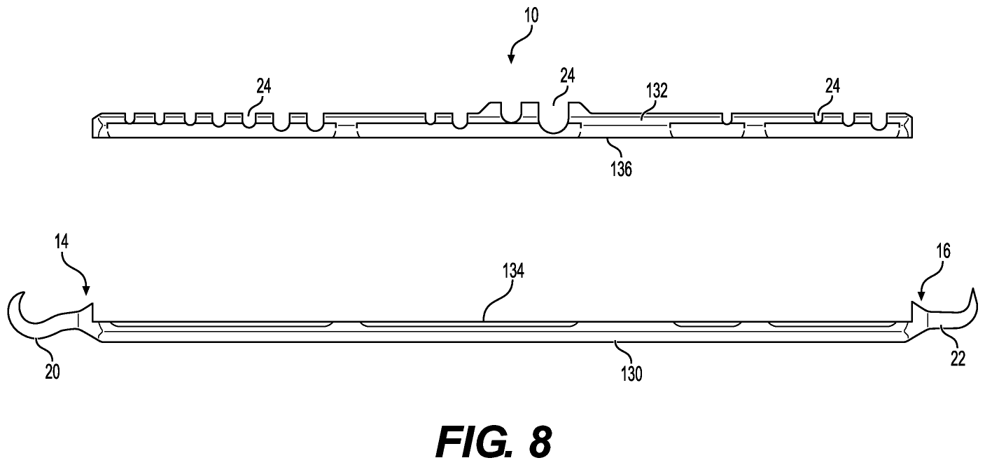

FIG. 8 illustrates another exemplary embodiment of ring seal removal tool 10. In the embodiment of FIG. 8, ring seal removal tool 10 may include bottom half 130 and top half 132. Top half 132 of ring seal removal tool 10 may be removably attachable to bottom half 130. For example, upper surface 134 of bottom half 130 and/or lower surface 136 of top half 132 may include one or more protrusions, indentations, and/or other latching mechanisms that may allow top half 132 to be attached to bottom half 130 of ring seal removal tool 10. In some exemplary embodiments, bottom half 130 and top half 132 may be removably attachable to each other via fasteners or clips. In one exemplary embodiment as illustrated in FIG. 8, bottom half 130 may include hook 20 and prying tip 22 extending from opposite ends of bottom half 130, and top half 132 may include cutouts 24 and/or one or more groups of cutouts (e.g., 90, 92, 94, 96, and/or 98) as discussed above. Thus, different top halves 132 including groups of cutouts (e.g., 90, 92, 94, 96, and/or 98) with a different selection or combination of width and height dimensions may be attachable to bottom half 130 allowing ring seal removal tool 10 to be used for a greater variety and number of ring seals. Although hook 20 and prying tip 22 have been described as attached to bottom half 130, it is contemplated that in some exemplary embodiments, hook 20 and prying tip 22 may extend from opposite ends of top half 132 of ring seal removal tool 10.

### INDUSTRIAL APPLICABILITY

The disclosed ring seal removal tool 10 may be used to remove and replace one or more ring seals during maintenance or repair of one or more components of, for example, a construction machine. For example, a construction machine such as a backhoe, a dozer, a milling machine, a paving machine, a dump truck, may include one or more components such as an engine, a hydraulic cylinder, and/or other components required for the operation of the machine. One or more of these components may include one or more ring seals for preventing leakage of fluids from within the component to an outside environment and for preventing entry of air, moisture, or debris from the external environment into the internal confines of the component. One or more ring seals of the component may require replacement after a period of use. The disclosed ring seal removal tool may be used to remove and replace a worn ring seal.

For example, consider the situation in which a ring seal is installed and seated in an indentation or ring seal groove of a machine component. Tip 74 and/or tip end 84 of hook 20 or prying tip 22, respectively, may be inserted between the ring seal and a wall of the ring seal groove. This may allow an operator to manipulate the elongated body 12 of ring seal removal tool 10 to lift and extract the ring seal out of the ring seal groove. After removing the ring seal, the operator may insert a section of the extracted ring seal into one of the cutouts 24 starting, for example, with a cutout 24 having a width smaller than the ring seal diameter and then into cutouts of ever increasing width or height. The operator may continue this process until the ring seal can be inserted into a cutout 24 in which planar surfaces 102, 104 contact the ring seal on either side without having to compress as the ring seal is inserted into the gap between planar surfaces 102, 104. The operator may push the ring seal in so that the ring seal may bottom out on curvilinear surface 106 and an upper surface of ring seal is coplanar with top surface 32 of ring seal removal tool 10. The operator may note a dimension of the particular cutout 24 and find a replacement ring seal having the same dimension. Thus, the disclosed ring seal removal tool 10 may help an operator to remove an existing worn out ring seal and determine the ring seal dimensions using the one or more cutouts in ring seal removal tool 10. The operator may be able to identify a replacement ring seal based on the determined dimensions for assembly of the replacement ring seal. The disclosed ring seal removal tool 10 may help an operator to quickly identify and retrieve a replacement ring seal having dimensions similar to that of the removed ring seal without the need for any additional measurement tools. The disclosed ring seal removal tool 10 may also provide the operator with confidence that the correct size of the replacement ring seal has been selected.

It is to be noted that when some exemplary embodiments are described in this disclosure as exhibiting a feature or characteristic, some or all the other exemplary embodiments described in this disclosure may also exhibit that same feature or characteristic. It will be apparent to those skilled in the art that various modifications and variations can be made to the disclosed ring seal removal tool. Other embodiments will be apparent to those skilled in the art from consideration of the specification and practice of the disclosed ring seal removal tool. It is intended that the specification and examples be considered as exemplary only, with a true scope being indicated by the following claims and their equivalents.

What is claimed is:

1. A ring seal removal tool, comprising:
an elongated body extending from a proximal end to a distal end;
a hook extending from the proximal end;
a prying tip extending from the distal end; and
a cutout in the elongated body, the cutout being configured to receive a portion of a ring seal having an outer diameter about equal to a width of the cutout.

2. The ring seal removal tool of claim 1, wherein
the elongated body includes a first surface and a second surface spaced apart across a height of the elongated body, and
the cutout extends into the elongated body from the second surface towards the first surface.

3. The ring seal removal tool of claim 2, wherein a height of the cutout is greater than or equal to the width of the cutout.

4. The ring seal removal tool of claim 3, wherein the cutout includes:
a pair of planar walls spaced apart along a longitudinal axis of the elongated body; and
a generally semi-cylindrical bottom wall extending between the planar walls.

5. The ring seal removal tool of claim 2, wherein the hook has
a shank attached to the elongated body,
a generally curvilinear body extending past the first surface in a first direction extending from the second surface towards the first surface, and
a tip projecting past the second surface in a second direction extending from the first surface towards the second surface.

6. The ring seal removal tool of claim 1, wherein the prying tip includes:
a shank extending from the distal end along a longitudinal axis of the elongated body; and
a tip portion extending from the shank in direction transverse to the longitudinal axis.

7. The ring seal removal tool of claim 6, wherein
the tip portion has a generally conical shape, and
the tip portion is disposed at an obtuse angle relative to the shank.

8. The ring seal removal tool of claim 1, wherein at least one of the prying tip and the hook is removably attached to the elongated body.

9. The ring seal removal tool of claim 1, wherein the elongated body has a polygonal cross-section.

10. The ring seal removal tool of claim 1, wherein the cutout is one of a plurality of cutouts.

11. The ring seal removal tool of claim 10, wherein the plurality of cutouts includes:
a first group of cutouts disposed adjacent to the proximal end of the elongated body; and
a second group of cutouts disposed adjacent to the distal end of the elongated body.

12. The ring seal removal tool of claim 11, wherein each of the first group of cutouts and the second group of cutouts includes cutouts having different widths.

13. The ring seal removal tool of claim 12, wherein the first group of cutouts includes:
a first cutout adjacent to the proximal end;
a second cutout adjacent to a central portion of the elongated body; and
a plurality of intermediate cutouts disposed between the first cutout and the second cutout,
wherein
the first cutout has a first width that is smaller than widths of the intermediate cutouts and the second cutout, and
the second cutout has a second width that is larger than the widths of the intermediate cutouts and the first width.

14. The ring seal removal tool of claim 10, wherein the elongated body includes:
a bottom half; and
a top half attachable to the bottom half, the top half including the plurality of cutouts.

15. The ring seal removal tool of claim 1, wherein the elongated body includes:
a proximal portion extending from the proximal end towards the distal end,
a distal portion extending from the distal end towards the proximal end, and
a central portion extending between the proximal portion and the distal portion, the central portion having a cross-sectional area larger than a cross-sectional area of the proximal portion or the distal portion.

16. The ring seal removal tool of claim 15, wherein the central portion includes at least one cutout having a height about equal to or greater than half of a height of the proximal portion of the elongated body.

17. A ring seal removal tool, comprising:
an elongated body extending from a proximal end to a distal end, the elongated body including a bottom surface and top surface spaced apart from the bottom surface in a height direction;
one of a hook or a prying tip attached to one of the proximal end or the distal end; and
a plurality of cutouts in the elongated body, each cutout extending from the top surface of the elongated body towards the bottom surface of the elongated body, and being configured to receive a portion of a ring seal having an outer diameter about equal to a width of the cutout.

18. The ring seal removal tool of claim 17, wherein the plurality of cutouts includes:
a first cutout adjacent to the proximal end;
a second cutout spaced apart from the first cutout; and
a plurality of intermediate cutouts disposed between the first cutout and the second cutout,
wherein
the first cutout has a first width that is smaller than widths of the intermediate cutouts and the second cutout, and
the second cutout has a second width that is larger than the widths of the intermediate cutouts and the first width.

19. The ring seal removal tool of claim 17, wherein the elongated body includes:
a proximal portion extending from the proximal end towards the distal end,
a distal portion extending from the distal end towards the proximal end, and
a central portion extending between the proximal portion and the distal portion, the central portion having a cross-sectional area larger than a cross-sectional area of the proximal portion or the distal portion.

20. The ring seal removal tool of claim 19, wherein the plurality of cutouts includes:
a first group of cutouts in the proximal portion; and
a second group of cutouts in the distal portion.
